(19) United States
(12) Patent Application Publication
(10) Pub. No.: US 2003/0195726 A1
(43) Pub. Date: Oct. 16, 2003

(54) Hybrid model generation method and program product

(76) Inventor: Koichi Kondo, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/388,663

(22) Filed: Mar. 17, 2003

(30) Foreign Application Priority Data
Mar. 15, 2002 (JP) 2002-073212

(51) Int. Cl. G06F 17/10

(52) U.S. Cl. 703/2

(57) ABSTRACT

A method of generating a hybrid model described in a hybrid model language for a system is disclosed. A description of a plurality of continuous system equations, which define a plurality of states of the system, is extracted from input data. The input data may be described in a format of state transition chart. The description of the plurality of continuous system equations is converted into a first part of a statement of the hybrid model. A description of a state transition is also extracted from the input data. The state transition may be caused by a discrete event. The description of the state transition is converted into a second part of the statement of the hybrid model. Then, the first part and the second part are combined to complete the statement, thereby completing the hybrid model.

### CROSS-REFERENCE TO RELATED APPLICATIONS

This application is based upon and claims the benefit of priority from the prior Japanese Patent Application No. 2002-073212, filed Mar. 15, 2002, the entire contents of which are incorporated herein by reference.

### BACKGROUND OF THE INVENTION

1. Field of the Invention

The present invention relates to a hybrid model generation method and a program product for generating a hybrid model used in behavioral simulations of a machine, plant, and the like.

2. Description of the Related Art

In recent years, upon simulating the behaviors of a machine, plant, and the like using a computer, a scheme called hybrid modeling is often used. A simulation using a hybrid model is called a “hybrid simulation”, and a system that makes such simulation behavior is called a “hybrid system”. A hybrid model combines a continuous system model expressing a state of a system component using simultaneous equations of ordinary differential equations or algebraic equations, and a state transition model expressing express state transition of the state expressed by such continuous system model upon occurrence (establishment) of an event. That is, the hybrid model expresses a system, the state expressed by the continuous system model of which is switched instantaneously in response to, e.g., an external event.

As a language that describes a hybrid model, HCC (Hybrid Concurrent Constraint Programming) created at the Xerox Palo Alto Research Center is known. HCC is under development, and is currently studied at the NASA Ames Research Center. HCC is a kind of technology called constraint programming, can handle ordinary differential equations or algebraic equations that express a continuous system model as constraints, and can describe these equations in random order. The hybrid model is completed by adding a description that controls state transition to such constraint description.

HCC conveniently allows to directly list up equations as constraints, and advantageously describes a complicated model. However, since HCC is a kind of programming language, thorough understanding of language specifications and the like is required as in other program languages. HCC is hard to understand among other programming languages, and it is difficult to master the ability to generate an HCC program, i.e., a hybrid model.

As another conventional technique, a technique which can describe a model equivalent to a hybrid model is known. For example, Matlab(™) products available from the MathWorks(™), Inc. are software tools, which are prevalently used mainly by engineers of a control system and the like. However, these software tools cannot directly describe an ordinary differential equation. For this reason, the contents of the ordinary differential equation must be analyzed to re-define them as a block diagram which is a combination of components such as integral components and the like. Note that an analysis apparatus described in, e.g., Jpn. Pat. Appln. KOKAI Publication No. 7-160673 is known as an example that uses a block diagram as a similar approach upon simulating a system expressed by ordinary differential equations, although this apparatus is not directly related to a hybrid model.

Even for an engineer (especially, a mechanical engineer), who has only a poor knowledge about a special programming language such as HCC and is not used to expression of a system using a block diagram or the like, which is ordinarily done by a control designer, it is preferable if he can intuitively and easily generate a hybrid model. A mechanical engineer or the like is used to describe the behavior of a target mechanism using ordinary differential equations. Also, it is easy for such engineer to practically list up state transitions of a system like in a case wherein products are passed to belt conveyors in turn in a convey system (e.g., transition from a state wherein a product is conveyed by belt A to a state wherein the product is conveyed by belt B). However, when a program based on an HCC language is generated based on such information or when ordinary differential equations are described using a block diagram, programming ability and model description ability, which are not directly related to a target product, are required, and it is very difficult to master such ability, i.e., much skill is required.

### BRIEF SUMMARY OF THE INVENTION

The present invention has been made in consideration of such situation, and has as its object to provide a hybrid model generation method and a computer program product, which supports the user to intuitively and easily generate a hybrid model without any skill.

According to one aspect of the present invention, there is provided a method of generating a hybrid model described in a hybrid model language for a system. A description of a plurality of continuous system equations, which define a plurality of states of the system, is extracted from input data. The input data may be described in a format of state transition chart. The description of the plurality of continuous system equations is converted into a first part of a statement of the hybrid model. A description of a state transition is also extracted from the input data. The state transition may be caused by a discrete event. The description of the state transition is converted into a second part of the statement of the hybrid model. Then, the first part and the second part are combined to complete the statement, thereby completing the hybrid model.

### BRIEF DESCRIPTION OF THE SEVERAL VIEWS OF THE DRAWING

FIG. 1 is a schematic block diagram showing the arrangement of a hybrid model generation apparatus according to an embodiment of the present invention;

FIG. 2 is a flow chart showing the process of generating a hybrid model by the hybrid model generation apparatus of the embodiment;

FIG. 3 is a view showing a mechanical device as an example of a generation target of a hybrid model, and showing its first state;

FIG. 4 is a view showing a mechanical device as an example of a generation target of a hybrid model, and showing its second state;

FIG. 5 is a view showing a mechanical device as an example of a generation target of a hybrid model, and showing its third state;

FIG. 6 is a view showing a mechanical device as an example of a generation target of a hybrid model, and showing its fourth state;

FIG. 7 is a state transition chart which expresses the four state changes of the mechanical device of the example, and dynamic equations corresponding to the respective states;

FIG. 8 is a simplified view of FIG. 7 which is to be considered in the embodiment;

FIG. 9 shows an example of an HCC language description obtained by converting input data expressed by the state transition chart in FIG. 8;

FIG. 10 is a view for explaining the setup of a neutral state in state transition conversion;

FIG. 11 shows a conversion result of ordinary differential equations in respective state of an example of a given vibration system into a block diagram;

FIG. 12 shows a GUI used to edit input data in a state transition chart format, and shows a case wherein a new state is defined;

FIG. 13 shows a GUI used to edit input data in a state transition chart format, and shows a case wherein a continuous system equation (ordinary differential equation) is input;

FIG. 14 shows a GUI used to edit input data in a state transition chart format, and shows a case wherein another state is defined;

FIG. 15 shows a GUI used to edit input data in a state transition chart format, and shows a case wherein transition of one of the two defined states is defined; and

FIG. 16 shows a GUI used to edit input data in a state transition chart format, and shows a case wherein transition of the other of the two defined states is defined.

### DETAILED DESCRIPTION OF THE INVENTION

An embodiment of the present invention will be described hereinafter with reference to the accompanying drawings.

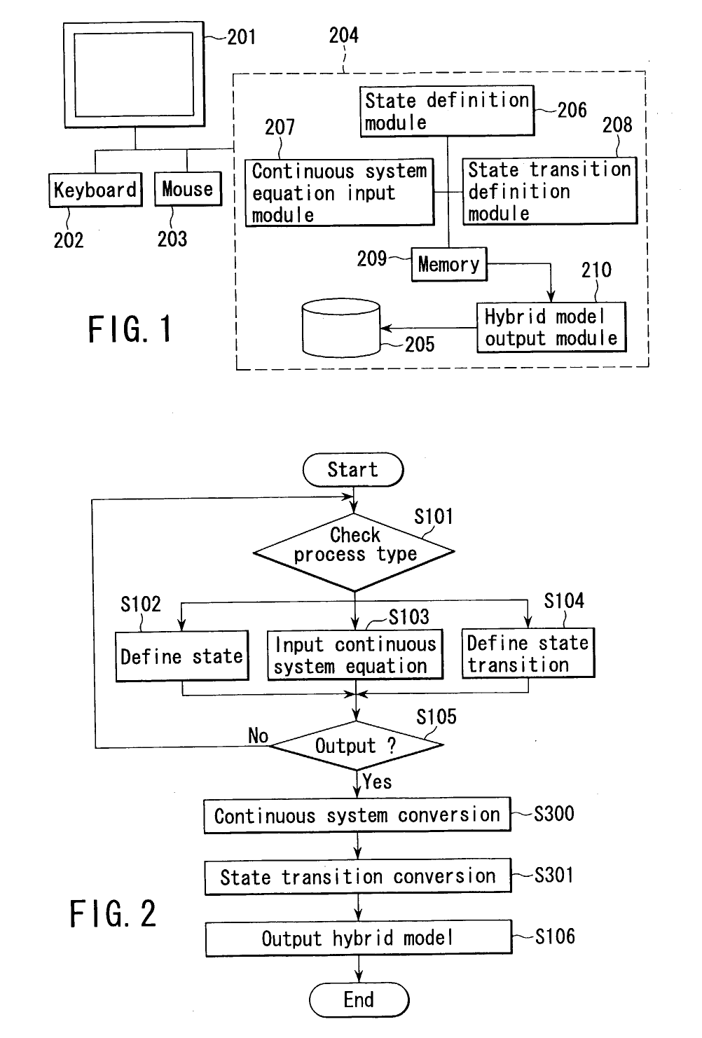

FIG. 1 is a schematic block diagram showing the arrangement of a hybrid model generation apparatus according to an embodiment of the present invention. This apparatus is implemented using a general computer (e.g., a personal computer (PC) or the like) and software which runs on the computer. The computer includes an engineering workstation (EWS) and the like suited to CAD and CAE. The present invention can be practiced as a program product which makes such computer execute a series of procedures associated with hybrid model generation.

As shown in FIG. 1, the hybrid model generation apparatus of this embodiment comprises I/O devices including a display 201, keyboard 202, mouse 203, and a processor 204 which includes a CPU (not shown), memory 209, secondary storage device 205, and the like. The processor 204 includes a state definition module 206, continuous system equation input module 207, state transition definition module 208, and hybrid model output module 210. These modules are implemented as software which collaborates with hardware that forms the computer, and run under a well-known operating system. The state definition module 206, continuous system equation input module 207, and state transition definition module 208 generate input data in a state transition chart format on the memory 209. This input data is read out when the hybrid model output module 210 accesses the memory 209. The readout data is converted into data in a hybrid model format in a procedure to be described later, and the converted data is output to the secondary storage device 205.

FIG. 2 is a flow chart showing the process of generating a hybrid model by the hybrid model generation apparatus of this embodiment. By performing the steps S101 to S105, input data represented in a state transition chart format is generated. The state transition chart format of this input data is then converted, by performing the steps S300 and S301, into a hybrid model format to be output.

Specifically, in the step S101, the process selects which one of the steps to launch, from the state definition step S102, continuous system equation inputting step S103, and state transition definition step S104, accepting a user instruction via an input device such as the keyboard 202, mouse 203, or the like. If there exists already input data that may correspond to a part of the hybrid mode, the process may automatically select needed one of these steps S102, S103 and S104 in consideration of the already input data. The selected step is then launched and executed. In every launched process, the user makes an input/edit operation by operating the mouse 203 and keyboard 202 on the display 201.

In the state definition step S102, the user can define states, which are supposed to be taken in a system. In the continuous system equation inputting step S103, the user can input one or more continuous system equations for each of the defined states. Further, in the state transition definition step S104, the user can specify state transitions between the defined states. Each step is described later in more detail. After the steps S102, S103 or S104 is terminated, the process proceeds to step S105.

Note here that a hybrid model can be completed only after all the steps S102, S103, and S104 have been conducted and input data of state transition chart has been completed. It is inquired of the user, in the step S105, if the hybrid model is to be output. If necessary, the process returns from the step S105 to the step S101 to launch the required step for completing the state transition chart.

The continuous system conversion step S300 and state transition conversion step S301 are procedures for converting data input in the state transition chart format in the steps S102, S103, and S104 into a hybrid model. Data of the hybrid model generated in these procedures is output to a file 205.

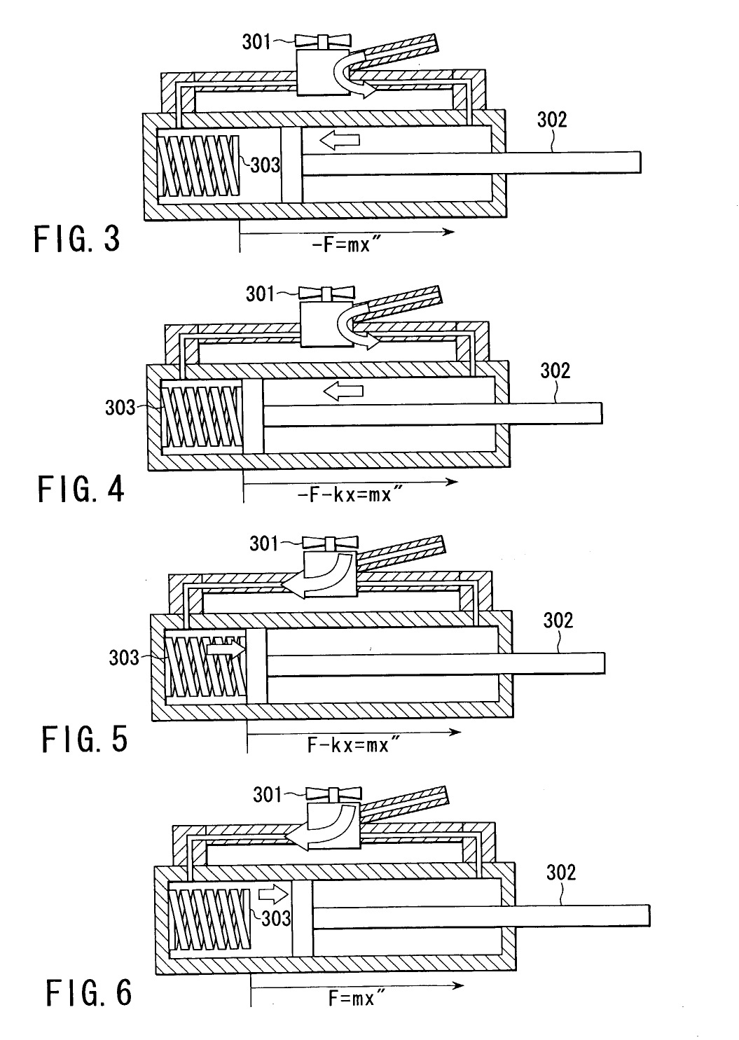

How to generate a hybrid model on the basis of input data in the state transition chart format will be described below taking a practical example. FIGS. 3 to 6 show a mechanical device as an example, and its state changes. This mechanical device is a simple mechanism in which a valve 301, piston 302, spring 303, and the like are arranged in a cylinder as a major building component. The valve 301 acts on pipes which connect cylinder regions partitioned by the piston 302, as shown in FIGS. 3 to 6. That is, the valve 301 changes an air flow externally supplied to the pipes to the right or left side on the page of each drawing in accordance with an external drive manipulation instruction. This drive manipulation instruction corresponds to an external event, and is expressed by “Right” or “Left”. The piston 302 moves inside the cylinder upon receiving the air pressure supplied from the pipe or the resilience from the spring 303. Note that one end of the spring 303 is fixed to the inner wall of the cylinder, and the other end is open. A case will be examined below wherein such mechanical device of this example assumes four states shown in FIGS. 3 to 6. In the state shown in FIG. 3, the drive manipulation instruction to the valve 301 is Right, and a leftward air pressure acts on the piston 302. A dynamic equation for the piston 302 is [−F=mx″] (minus indicates the left direction on the page of FIG. 3). FIG. 4 shows a state wherein the piston 302 has moved and contacted the spring 303. In this state, since the reaction force from the spring 303 is generated, a dynamic equation for the piston 302 is [−F−kx=mx″], and is changed from that in FIG. 3.

FIG. 5 shows a state wherein the drive manipulation instruction has changed from Right to Left, i.e., a state wherein the direction of the air flow has changed, and the dynamic equation has further changed to [F−kx=mx″]. FIG. 6 shows a state wherein the piston 302 has further moved from the state in FIG. 5, and the reaction force from the spring 303 has disappeared. In this state, the dynamic equation has changed to [F=mx″].

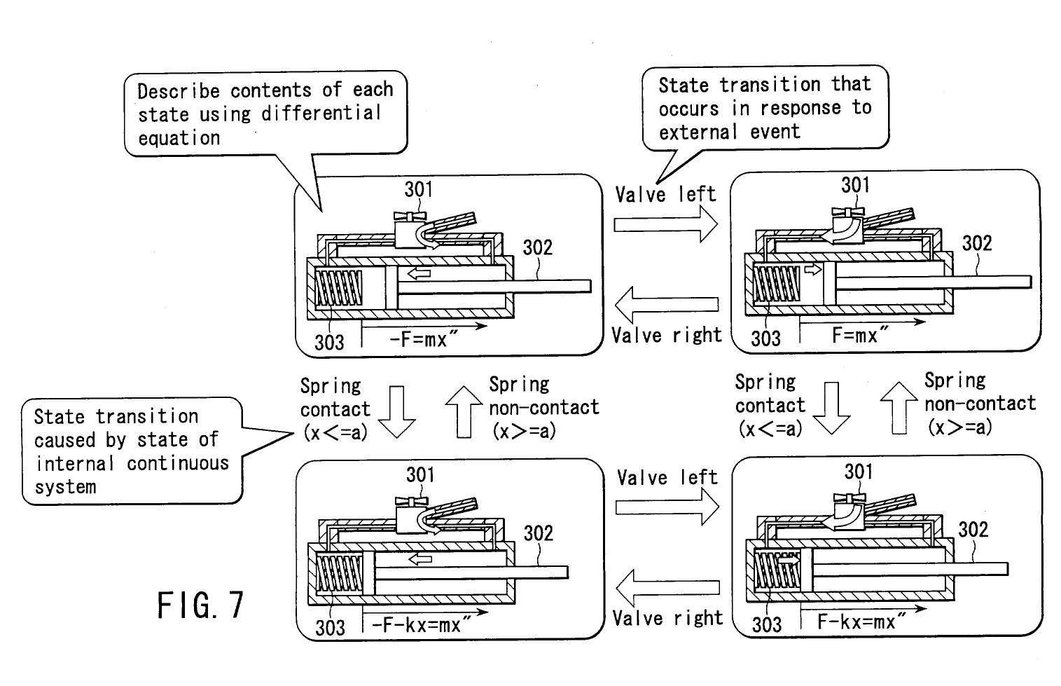

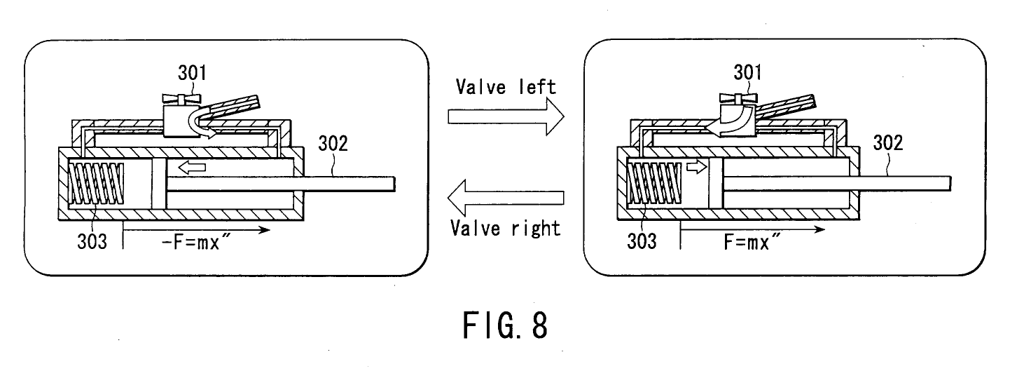

FIG. 7 shows a state transition chart that expresses the four state changes and the dynamic equations for the piston 302 corresponding to these states in the mechanical device of the above example. A hybrid model to be generated according to the present invention is generated by applying conversion processes (to be described later) to input data expressed by the state transition chart which includes both state transitions shown in FIG. 7 and ordinary differential equations (or algebraic equations; they may form simultaneous equations) that describe the respective states in principle. FIG. 8 further simplifies FIG. 7 so as to plainly explain the process for converting input data and outputting the converted data as a description of a hybrid model. In this case, only two states and state transition between them will be examined.

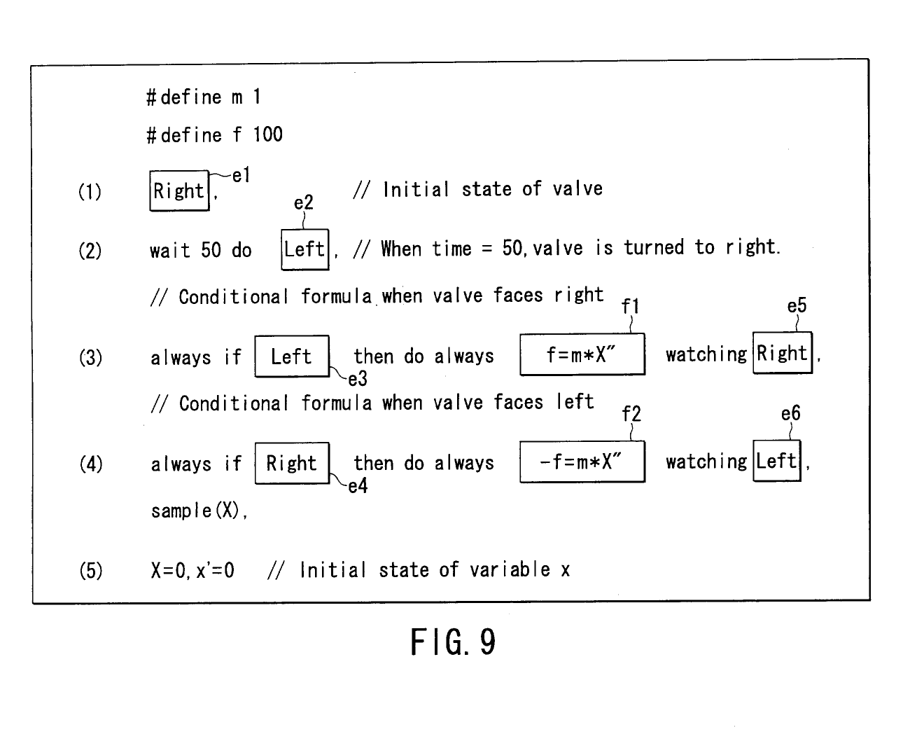

FIG. 9 shows an example of an HCC language description obtained by converting the input data expressed by the state transition chart in FIG. 8. Statements (1), (2), and (5) shown in FIG. 9 describe the initial state and drive conditions such as a valve manipulation timing and the like of the mechanical device of this example. Statements (3) and (4) correspond to state transition expressions in FIG. 8. In the HCC language, dynamic equations can be directly described in a program, as described above. A precondition required to transit to each state can be described after “always if” at the head of the statement, and a condition required to transit from each state to the next state can be described after “watching” at the end of the statement. The hybrid model output module 210 automatically appends expressions such as “always if”, “watching”, and the like unique to the HCC language. Note that hybrid model generation according to the present invention is not limited to only the HCC language as a hybrid constraint programming language, but can be practiced for other programming languages having functions equivalent to the HCC language.

In the hybrid constraint programming language, statements are not sequentially executed in the order that they are described in the program shown in FIG. 9 (the order of (1) to (5) in FIG. 9). In other words, statements which are to be effected are searched along the time axis along which a simulation is executed, and are executed. That is, the description order of statements (1) to (5) in the program is not related to their execution order. For example, when a simulation starts, only (1) and (5) are valid (effected). At that start point, since event “Right (e1 in FIG. 9) is generated by statement (1), event “Right” (e4) as the precondition of statement (4) is true, and dynamic equation f2 of that statement (4) is valid. That is, a simulation begins to be executed to have the state illustrated on the left side of the page of FIG. 8 as an initial state.

According to the program described in the HCC language shown in FIG. 9, when the time has reached “50”, statement (2) becomes valid, and event “Left” (e2) is generated. Accordingly, the condition (event e6 described after “watching”) of statement (4) becomes valid, and dynamic equation f2 of that statement (4) becomes invalid. Instead, the precondition (event e3) of statement (3) becomes true, and dynamic equation f1 becomes valid.

For example, a practical sequence for converting the input data expressed by the state transition chart in FIG. 8 into a hybrid model described in the HCC language (hybrid constraint programming language) in FIG. 9 is as follows. That is, in the continuous system conversion step S300 in FIG. 2, simultaneous ordinary differential equations as descriptions of respective states in the input data expressed by the state transition chart are extracted, and are transcribed to data in a hybrid model format of the HCC language. This process is done using the memory 209 in FIG. 1. Since the description order of statements makes no sense in the HCC language, as described above, such order need not be considered upon transcription.

In the continuous system conversion step S300, when a plurality of ordinary differential equations form simultaneous equations, they are decomposed into individual equations, and are converted into a predetermined format. For example, when dynamic equation f1 in FIG. 9 forms simultaneous equations with [y−0], the part of this dynamic equation f1 is converted into a format that specifies simultaneous equations (may have two, three, or more unknowns) using { } like {f=m*x″, y=0}. In this format, equations that form simultaneous equations are delimited by “,” (comma).

Alternatively, by adding a new program description “(6) always if Left then do always y=0 watching Right” to the HCC language description of FIG. 9, the same effect can be obtained without specifying simultaneous equations using { }. This is because statement (3) and newly added statement (6) have the same precondition and transition condition, and a processing system of the hybrid constraint programming language can automatically solve the dynamic equations of statements (3) and (6) as simultaneous equations.

Subsequently, in the state transition conversion step S301 shown in FIG. 2, events (including both an external event and an internal event resulting from an internal state) that cause state transitions are extracted from the input data expressed by the state transition chart. Since the example of FIG. 8 includes only one precondition required to transit to the self state and only one transition condition required to transit from the self state to another state in respective states, event names can be directly transcribed to the preconditions (descriptions that follow “always if”) and transition conditions (descriptions that follow “watching”) in statements (3) and (4) in FIG. 9. In this way, conversion into the hybrid constraint programming language ends. However, in the example shown in FIG. 7, state transitions take place in a more intricate manner. For example, when valve left event “Left” is generated, the transition destination varies depending on whether the previous state is the upper or lower one in FIG. 7. In this manner, when the transition destination varies depending on the state before transition even when the same event is generated, that event must be distinguished. Let “Left1” be “valve left event” on the upper side in FIG. 7, and “Left2” be “valve left event” on the lower side in FIG. 7. Furthermore, new variable “state” that indicates a state is introduced. Assume that variable “state” assumes 1 in case of the upper left state in FIG. 7, 2 in case of the lower left state, 3 in case of the upper right state, and 4 in case of the lower right state. Using this variable, when external event “left” is generated, event “Left1” or “Left2” is generated in correspondence with the internal state indicated by variable “state”. A program description that pertains to event “Left” is as follows:

always if Left1 then always {F=m x″, state=3} watching {Right∥NoContact)

always if Left2 then always {F−k x=m x″, state=4} watching (Right∥Contact}

always if (Left && state==1) then Left1

always if (Left && state==2) then Left2.

Note that “NoContact” and “Contact” are events associated with contact/non-contact of the spring. These events can be similarly understood as “Left” events, but the whole program is not described since a description will become complicated. In this way, the state transition conversion step S301 checks whether or not an identical event consequently causes transition to different states. If such case occurs, that event is decomposed into internal events and names are assigned to these events like in a case wherein Left is decomposed into Left1 and Left2.

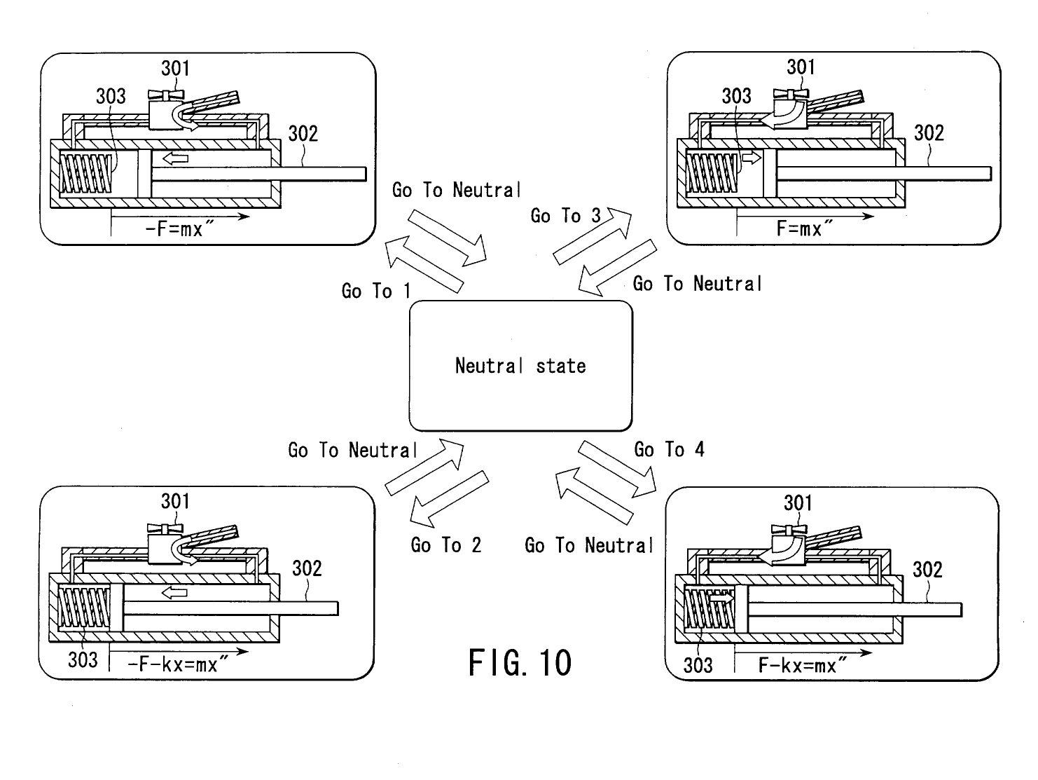

When the transition condition becomes complicated, it is also effective to apply the following state transition conversion sequence that adopts an intermediate transition state. The alternative state transition conversion step (S301′ updating the reference numeral of S300 shown in FIG. 2) in such case sets a neutral state shown in FIG. 10 for state transitions in FIG. 7. All states transit to a neutral state in response to a “GoToNeutral” event. In addition, variables “PrevState” and “Eventtype” are introduced to store the state before transition to the neutral state. As a result, the state transitions in FIG. 7 can be expressed by:

always if Right then do always Eventtype=Right watching {GoTo1∥GoTo2∥GoTo3∥GoTo4}

always if Left then do always Eventtype=Left watching {GoTo1∥GoTo2∥GoTo3∥GoTo4}

always if Contact then do always Eventtype=Contact watching {GoTo1∥GoTo2∥GoTo3∥GoTo4}

always if NoContact then do always Eventtype=NoContact watching {GoTo1∥GoTo2∥GoTo3∥GoTo4}

always if Goto1 then do always {prevState=1, −F=m x′} watching GoToNeutral

always if Goto2 then do always {prevState=2, −F−kx=m x′} watching GoToNeutral

always if Goto3 then do always {prevState=3, F=m x′} watching GoToNeutral

always if Goto4 then do always {prevState=4, F−k x=m x′} watching GoToNeutral

always if (GoToNeutral && Eventtype==NoContact && prevState==2) then GoTo1

always if (GoToNeutral && Eventtype==Right && prevState==3) then GoTo1

always if (GoToNeutral && Eventtype==Contact && prevState==1) then GoTo2

always if (GoToNeutral && Eventtype==Right && prevState==4) then GoTo2

always if (GoToNeutral && Eventtype==NoContact && prevState==4) then GoTo3

always if (GoToNeutral && Eventtype==Left && prevState==1) then GoTo3

always if (GoToNeutral && Eventtype==Contact && prevState==3) then GoTo4

always if (GoToNeutral && Eventtype==Left && prevState==2) then GoTo4.

That is, state variables “Eventtype” are defined for external events such as Right and the like, and internal events such as Contact and the like. Setup processes of these state variable values are generated in association with corresponding events. For example, a program description “always if Right then do always Eventtype=Right watching {GoTo1∥GoTo2∥GoTo3∥GoTo4}” is generated in this step. Then, operations that represent transitions to respective states (arrows of valve left and the like in FIG. 7) are listed up, and logical formulas which express operations are generated in correspondence with the respective arrows. For example, “always if (GoToNeutral && Eventtype=Contact && prevState=3) then GoTo4” is such example, and includes a set of a state before transition, and an event that causes transition. Such expressions can be listed up for all arrows.

As described above, the input data expressed by the state transition chart can be converted into a hybrid model described in the HCC language by the continuous system conversion step S300 and state transition conversion step S301. Note that the input data may be expressed by a state transition table in place of the state transition chart. Also, the execution order of the continuous system conversion step S300 and state transition conversion step S301 may be reversed.

A case will be explained below a model in a block diagram format is obtained from input data expressed by a state transition chart, and the obtained model is output. In this case, the continuous system conversion step S300 and state transition conversion step S301 may be executed according to the flow in FIG. 2, but only a model in a block diagram format may be output.

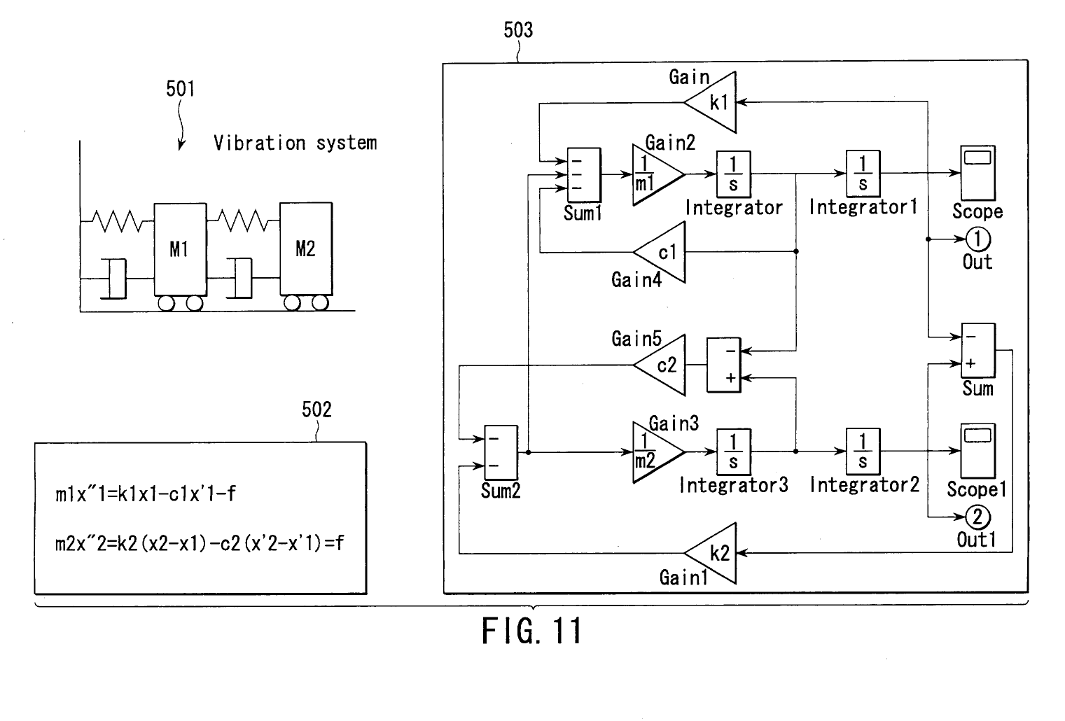

FIG. 11 shows the conversion result of ordinary differential equations in respective state of an example of a given vibration system into a block diagram. A vibration system 501 having M1 and M2 is expressed by ordinary differential equations 502. A block diagram 503 expresses these ordinary differential equations. Conversion from the format of 502 into 503 is known to those who are skilled in the art, and a description thereof will be omitted. For more details, refer to the software manual of Simulink available from the MathWorks, Inc., and the description of Jpn. Pat. Appln. KOKAI Publication No. 7-160673. The entire contents both of which are incorporated herein by reference.

Such model in the block diagram format is generated using input data of simultaneous ordinary differential equations input at the continuous system equation input module 207 which forms a GUI. This process of this embodiment is effective to collaboration with a simulation that cannot directly describe ordinary differential equations unlike the HCC language.

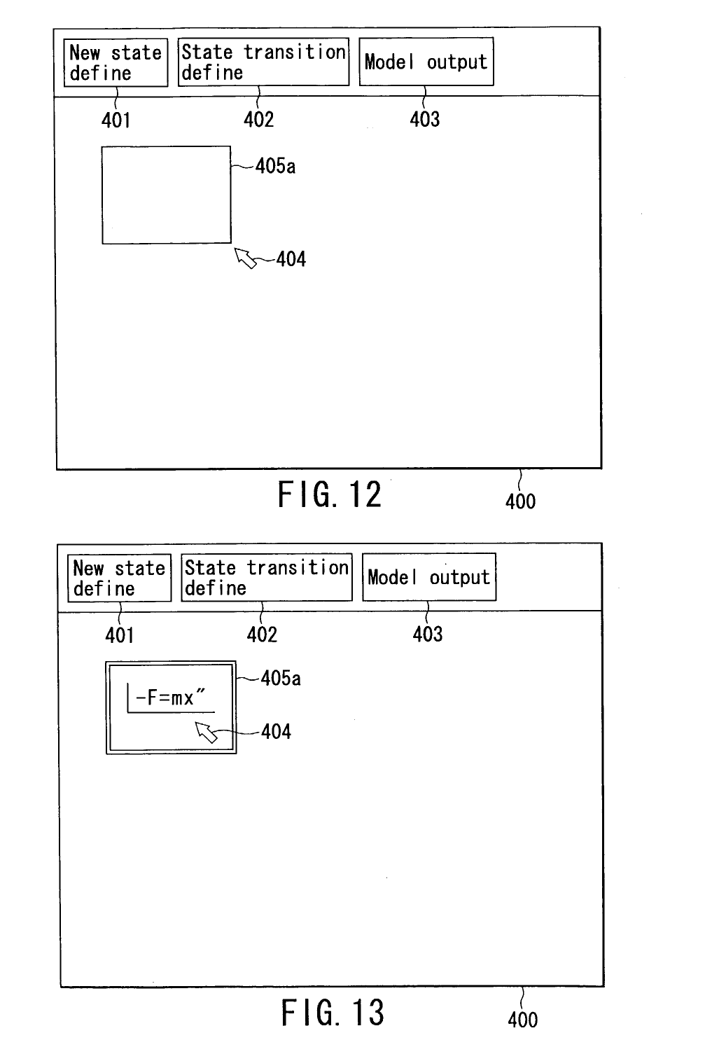

A configuration example and operation sequence of a GUI (Graphical User Interface) provided by the processor 204 will be described below with reference to FIGS. 12 to 16. A state transition drawing window 400 shown in FIGS. 12 to 16 is displayed on the display 201. On this window 400, the user can designate the process type and make various edit operations using a mouse pointer 404 that moves in response to the operation of the mouse 203. The process type includes three menu buttons, i.e., a new state define button 401, state transition define button 402, and model output button 403 in this example.

FIG. 12 shows a state wherein the user has selected the new state define button 401 and has drawn a rectangle 405a indicating the first state on a work area on the window 400 by operating the mouse 203. When the user moves the mouse pointer 404 into the already drawn rectangle 405a, a state that allows to input a continuous system equation is automatically set. In this case, the user then inputs a dynamic equation using the keyboard 202, as shown in FIG. 13.

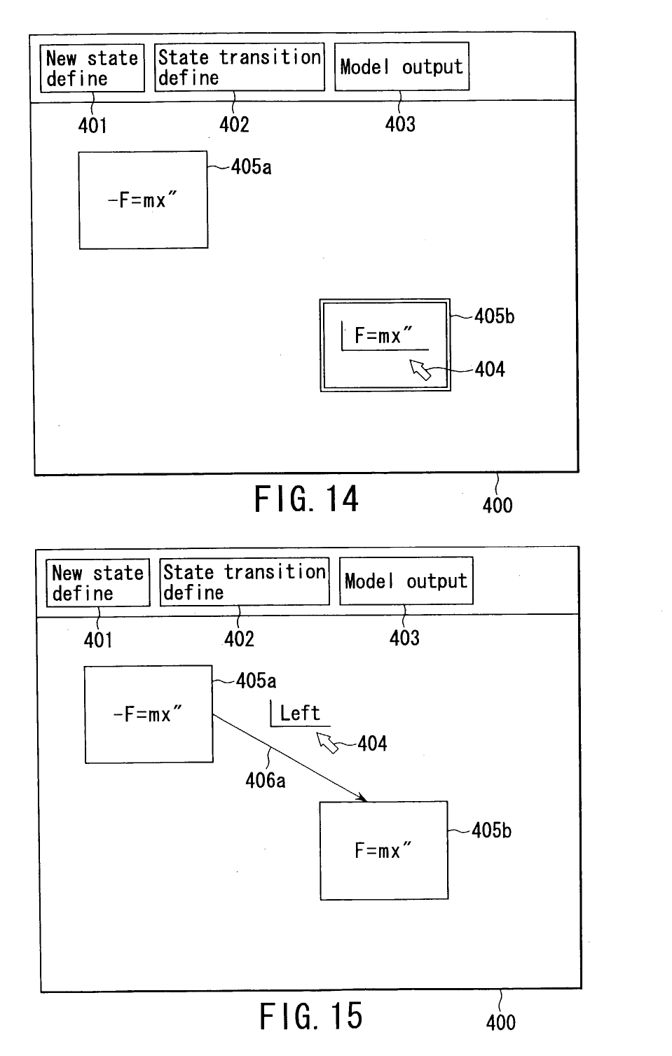

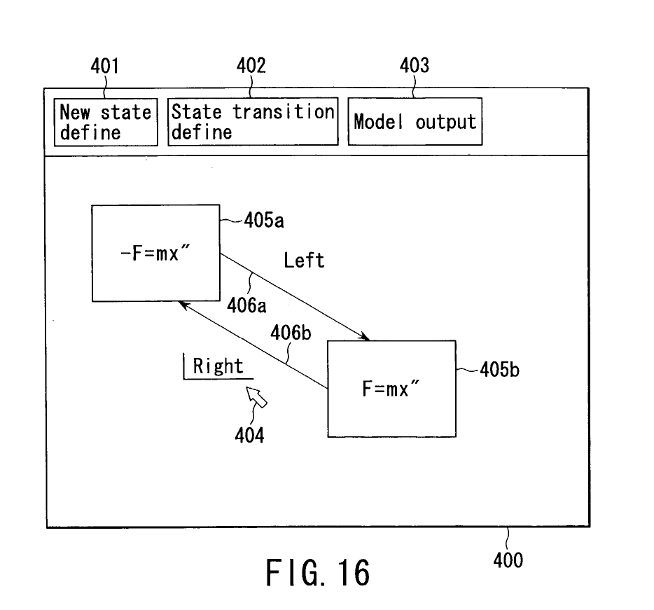

FIG. 14 shows a state wherein the user has selected the new state define button 401 again, has drawn a rectangle 405b indicating the second state on the work area on the window 400 in addition to the rectangle 405a indicating the first state, and has input a dynamic equation. In this state, when the user selects the state transition define button 402, he or she can input a transition between the states using an arrow (FIG. 15). The operation in this case is attained by dragging the mouse 203 while designating, e.g., the rectangle 405a. Furthermore, the user can input event “Left” near an arrow 406a as the precondition for the designated state transition. FIG. 16 shows a state wherein the user has additionally drawn an arrow 406b indicating another state transition.

When the user selects the model output button 403 in this state, the data input so far is settled as input data expressed by a state transition chart, and the aforementioned conversion processes are executed. Then, the conversion result (a hybrid model in the HCC language, for example) is output to a predetermined file 205.

According to the aforementioned embodiment of the present invention, state transitions can be described on a window of a computer using a graphical interface. For each state, ordinary differential equations or algebraic equations can be directly input. Furthermore, based on the data input in this way, a conversion output into a program format of hybrid constraint programming or a format that solves ordinary differential equations using a block diagram can be obtained, and hybrid modeling can be implemented very efficiently.

Therefore, even an engineer (especially, a mechanical engineer), who has only a poor knowledge about a special programming language such as HCC and is not used to expressing a system using a block diagram or the like, which is ordinarily done by a control designer, can intuitively and easily generate a hybrid model.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of generating a hybrid model described in a hybrid model language for a system, the method comprising:
extracting a description of a plurality of continuous system equations which define a plurality of states of the system from input data, the input data being described in a format of state transition chart;
converting the description of the plurality of continuous system equations into a first part of a statement of the hybrid model;
extracting a description of a state transition from the input data, the state transition being caused by a discrete event;
converting the description of the state transition into a second part of the statement of the hybrid model; and
combining the first part and the second part to complete the statement, thereby completing the hybrid model.

2. A method according to claim 1, wherein the description of the state transition describes a first condition required to transit from another state to a state of interest, and a second condition required to transit from the state of interest to another state.

3. A method according to claim 1, wherein the hybrid model language includes a hybrid constraint programming language.

4. A method according to claim 1, wherein the discrete event includes at least one of an external event and an internal event resulting from an internal state.

5. A method according to claim 1, further comprising:
defining a neutral state to which the plurality of states of the system defined by a plurality of continuous system equations can commonly transit; and
defining a plurality of events which cause the state transition to the neutral state, and the state transition from the neutral state.

6. A method according to claim 1, further comprising:
converting the description of the continuous system equation into another data described in a format of block diagram.

7. A computer program product comprising a computer usable medium having computer readable program code means for causing a computer to generate a hybrid model described in a hybrid model language for a system, the computer readable program code means in said computer program product comprising:
program code means for causing the computer to extract a description of a plurality of continuous system equations which define a plurality of states of the system from input data, the input data described in a format of state transition chart;
program code means for causing the computer to convert the description of the plurality of continuous system equations into a first part of a statement of the hybrid model;
program code means for causing the computer to extract a description of the state transition from the input data;
program code means for causing the computer to convert the description of the state transition into a second part of the statement of the hybrid model, the state transition being caused by a discrete event; and
program code means for causing the computer to combine the first part and the second part to complete the statement, thereby completing the hybrid model.

8. A program product according to claim 7, wherein the description of the state transition describes a first condition required to transit from another state to a state of interest, and a second condition required to transit from the state of interest to another state.

9. A program product according to claim 7, wherein the hybrid model language includes a hybrid constraint programming language.

10. A program product according to claim 7, wherein the discrete event includes at least one of an external event and an internal event resulting from an internal state.

11. A program product according to claim 7, further comprising:
program code means for causing the computer to define a neutral state to which a plurality of states of the system defined by the plurality of continuous system equations can commonly transit; and
program code means for causing the computer to define a plurality of events which cause the state transition to the neutral state, and the state transition from the neutral state.

12. A program product according to claim 7, further comprising:
program code means for causing the computer to convert the description of the continuous system equation into another data described in a format of block diagram.
